(19) United States
(12) Patent Application Publication
(10) Pub. No.: US 2002/0022971 A1
(43) Pub. Date: Feb. 21, 2002

(54) Software rental system, software rental method, and computer program for being executed on the software rental system

(76) Inventors: Masanori Tanaka, Tokyo (JP); Daisuke Inuzuka, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 09/932,922

(22) Filed: Aug. 21, 2001

(30) Foreign Application Priority Data
Aug. 21, 2000 (JP) 2000-249754

(51) Int. Cl. G06F 17/60

(52) U.S. Cl. 705/1

(57) ABSTRACT

A software rental system that offers commercial software products to client systems on the rental basis over a communication network is disclosed, wherein the commercial software product is installed on the client terminal in the client system. Every software product installed on the client terminal has a first license manager built thereinto. When a software component of the software product that resides on the client terminal is activated and terminated by the user, the first license manger is enabled to intercept the start time and end time, and send this time information, over the communication network, to a second license manager within the appropriate server system that has licensed the user to use the software product. On the server system, the start time and end time information received from the first license manager is analyzed, and the usage fee to be charged to the user is calculated. A firewall is provided between the client systems and the server systems so that only signals that conform to a particular communication protocol can be passed through the firewall. The communications between the client systems and the server systems over the communication network can occur without having to care about the communication paths along which the communications travel and as if the first license manager in the client systems and the second license manager in the server systems reside on the same LAN.

### BACKGROUND OF THE INVENTION

1. Field of the Invention

The present invention relates to a software rental system that provides commercial software products on the rental basis over a communication network. Furthermore, the present invention relates to a software rental method that allows commercial software products to be offered on the rental basis over the computer network, and a computer program that may run on the software rental system.

2. Description of the Prior Art

As computers that are implemented by hardware are used more widely, more commercial software products that may be installed on those computers are developed, and are commercially available on the market. In the earlier years when individual programs that were offered on the commercial basis were small, it was usual that users purchased those programs from vendors that offered them. For example, when a company wishes to have an inventory management software product installed on its computer, the company developed such software program in house, or otherwise the company had an external software house (a vendor that develops and sells software) develop the software program that the company required, from which the company purchased the program.

For the recent years, hardware and software have advanced remarkably. In particular, software has advanced rapidly, and has become more sophisticated, more complicated, and larger.

As software is advancing, a software product that comprises a collection of individual functional software components, parts, or elements packaged into the product has been available on the commercial market. In the description that follows herein, when the phrase “commercial software product that comprises a collection of individual functional software components”, or simply “commercial software product”, or more simply “software product” or “product” is referred to, it should be understood to mean “commercial software product that comprises a collection of individual functional components, parts or elements”, unless otherwise specified. In addition, the term “component or components” should be understood to include “software component or components”.

In the CAD (Computer Aided Design) field, for example, there are several types of CAD systems, depending upon the particular applications or purposes for which they are used. For example, one type of the CAD system, which is intended for use in the electronic circuit designing application, contains software that is programmed to provide several individual functions that may be executed on the computer independently of each other. Those functions are implemented on the corresponding software components, respectively. For example, one function is to allow the user to edit the transistor or integrated circuit (IC) layout diagrams produced on the CAD system, another function is to allow the user to simulate the waveforms of the output signals from the discrete electronic elements on the designed circuit layout diagrams, another function is to allow the user to determine the optimum wiring diagrams for the circuit boards, such as the multi-layer printed circuit boards, and so on. Typically, this type of CAD system is primarily used by the electronic device manufactures.

Another type of the CAD system, which is intended for use in the machinery designing application, contains software that is programmed to provide the sophisticated computing functions that are executed on the computer to allow the user to calculate the mechanical strength for a particular structural object design, based on the materials and shapes of the structural object, as well as to provide the high-level functions that are executed on the computer to allow the user to simulate any possible vibrations that may be produced on the structural object. Typically, this type of CAD system is primarily used by the manufacturers of machinery.

Those software packages or products in the respective CAD applications shown above are only one example. There are also many other applications, in which software is developed and programmed to meet the requirements for the respective applications. As those applications advance rapidly, software becomes more sophisticated, more complicated and larger accordingly. In order to meet the needs of the particular application, a commercial software product, which may also be referred to as an application program, may include an increasing number of individual functional software components that are implemented by program code and may run on the computer independently of each other.

More recently, the EDA (Electronic Design Automation) system is commercially available. The EDA system contains a very expensive software package, which includes a collection of individual functional software components. Usually, the user of the EDA system is only interested in using any one of the individual functional components contained in the software package. As a project that users are working with is growing, the users may have to replace the existing tool with a new version of the tool. If this occurs frequently, it may impose a great cost burden upon the user.

Nowadays, there is a vendor that acts as an intermediary between the software owner and the software user. The vendor has the various forms. Typically, one vendor purchases a software product from a software house, and sells a license to use the software product to an end user. Specifically, the vendor licenses the end user to use the software product, and the end user pays the software usage fee to the vendor. This relieves the user from the burden of purchasing the expensive software package. Also, according to this, the latest version of software has now become available to the end user at the reasonable cost.

Of recent years, the LAN (local area network) is developing, and the WAN (wide area network), such as the Internet, that interconnects those LAN's is also developing. Vendors may utilize those networks to obtain the information from the user who is using a particular software product, such as the usage time, and charge the usage fee to the user, based on the usage time information.

A prior computer software rental method and system that is similar to that described above is disclosed in Japanese patent application, now published for the public examination under No. H7 (1995) - 89305, wherein software products are offered to users on the rental basis, and the usage fees are charged to the user accounts. In this prior method and system, user terminals are connected to vendor host computers through a communication network, and the information on the time at which a user started to use a particular software product (start time) and the time at which the user ended using the software product (end time) may be logged on the vendor host computer. The usage fee may be charged to the user, based on the start time and end time information recorded in the log.

In the above prior system, when a user wishes to use a particular software product, the user may communicate with the vendor host computer, requesting that the vendor permit the user to use the software product. In response to this request, the host computer may permit the user to use the software product. When the user begins to use the software product as licensed, the start time is logged. Then, the user is disconnected once from the host computer. When the use of the software product ends, the vendor host computer is then connected again to the user, and the end time is logged. On the vendor side, the usage time may be calculated from the start time and end time, and the usage fee may be charged to the user, based on the calculated usage time.

More recently, the networking environment is developing so that it can accommodate the Internet and Intranets. In this networking environment, the communications between the devices and/or terminals that are located remotely from each other occur by using the TCP/IP (Transport Control Protocol/Internet Protocol). Usually, the device or terminal that resides on the connected side is called “the client”, and the device or terminal that resides on the connecting side is called “the server”. The firewall is installed between the Intranet and the Internet for the security reasons. The firewall provides the facilities that only allow signals or data (packets) that conform to a particular protocol such as HTTP (Hypertext Transfer Protocol) and FTP (File Transfer Protocol) to flow through the firewall in order to secure the Intranet.

When software rental activities described above occur between the client terminal and server computer over the Internet, the communication packets that are exchanged between them should have the format that allows the packets to pass through the firewall. When such client-to-server system is implemented, most communications occur by using the HTTP protocol. For example, when the user on the client terminal communicates with the server computer using the Web browser, software program coded with HTML (Hypertext Markup Language), can be obtained from the WWW server using HTTP.

The recent trend is that software is becoming more sophisticated, more complicated, and larger. To reflect this trend, software products that are offered on the commercial basis generally include a collection of individual functional components that can run independently of each other.

It is noted, however, that the conventional software rental system offers all rental software products as complete packages, for which the system charges the usage fee, based on the start time and end time. This usage fee covers all of the software components contained in the software package, even though there are some of the software components that are actually not used by the user. On the sites such as the electrical/electronic, machinery and construction fields, for example, it is noted that some of the software components in the package that are being used may change as the project progresses, and some of the software components may be used more intensively. As each of the software components in the package must be licensed when those software components are used, one particular software component may be shared by multiple users. In this case, the number of users that are allowed to use the same software component is restricted. When the same software component is shared by multiple users, another problem occurs. That is, in case the frequency at which such single software component is used should reach its maximum peak or limit, the users could not continue to use that software component. In order to avoid such situation, users may be divided into several groups, and each group may be allowed to use the same software component at different times. In this case, other components that may not have reached the respective maximum peaks or limits and therefore may be available at any time might be left unused.

It is also noted that the conventional software rental system is not capable of keeping track of the usage status, such as the usage frequency, for each of the individual software components in the package. Thus, the system does not provide the facility that allows the user to analyze the actual usage of the software or each software component in detail.

### SUMMARY OF THE INVENTION

One object of the present invention is to provide a software rental system that operates across a communication network such as the Internet, wherein the system includes a client's system including a terminal on which a commercial software product being rented resides, the said commercial software product containing a first license manager, a server system including a server computer on which a second license manager is installed, and a firewall installed between the client system and server system interconnected across the Internet, the firewall only allowing the signals that conform to a particular communications protocol to flow through the firewall, and wherein the system keeps track of the usage status of the rented commercial software product, and calculates the usage fee for the software product, by allowing the first license manager and second license manager to communicate with each other, the communications between the first and second license managers occurring along the communication route that is transparent to the license managers and as if the license managers reside in the same LAN (local area network).

Another object of the present invention is to provide a software rental system that operates across a communication network such as the Internet, for offering commercial software products, each comprising a collection of individual functional software components, wherein the system provides the facilities for keeping track of the usage status of each of the software components contained in the product, and charging the usage fee for each software component based on the usage status.

In order to attain the above objects, a first aspect of the present invention is to provide a software rental system that operates across the communication network to offer commercial software products to client terminals included in a client system on the rental basis, wherein the software rental system includes one or more client systems and server system that can be connected to the client systems across the communication network and including one or more server computers, said server system including:

first means for receiving, over the communication network, a request to use a commercial software product from a client terminal in a client systems;

in response to the receipt of the request by said request receiving means, second means for authenticating the user on the client terminal in a client system by checking the identification information received with the request over the network;

after the user is authenticated by said authenticating means, third means for licensing the user to use the software product;

fourth means for obtaining, across the network, the usage status information of the software product licensed by said licensing means and being used on the client terminal in a client system; and

fifth means for calculating the usage fee for said software product, based on the usage status information received from said fourth means, and charging the usage fee for the software product to the user.

In the present invention, client system can be comprised by a terminal represented such as by a computer or by a local area network (LAN) to which a plurality of terminals, each of said terminals is represented such as by a computer, are connected.

In order to attain the above objects, a second aspect of the present invention is to provide a software rental system that operates across the communication network to offer commercial software products to client terminals included in a client system on the rental basis, each commercial software product including a collection of individual functional software components, wherein the software rental system includes one or more client systems and server system that can be connected to the client systems across the communication network and including one or more server computers, said server system including:

first means for receiving, over the communication network, a request to use a commercial software product from a client terminal in a client systems;

in response to the receipt of the request by said request receiving means, second means for authenticating the user on the client terminal in a client system by checking the identification information received with the request over the network;

after the user is authenticated by said authenticating means, third means for licensing the user to use each of the individual functional software components contained in the software product;

fourth means for obtaining, across the network, the usage status information of each of the licensed individual functional software components contained in the licensed software product and being used on the client terminal in a client system; and

fifth means for calculating the usage fee for each of the individual functional software components contained in the software product, based on the usage status information received from said fourth means, and charging the usage fee for each individual software component to the user.

In the above description, the commercial software product and/or the commercial software product including a collection of individual functional software components that are offered on the rental basis, may be installed on the user's client terminal in the client system. It should be noted, however, that the commercial software products installed on the client terminal cannot run on the client terminal, unless licensed to use them. In order to use the commercial software product on the client terminal, the user must communicate with the server computer in the appropriate server system over the network, and must be authorized to use it.

The software rental system according to the second aspect of the present invention may be configured so that the fourth means, or means for obtaining the usage status information, obtains the usage time information for each individual functional software component running on the client terminal in the client system, and the fifth means, or means for calculating the usage fee, calculates the usage fee for each component, based on the usage time information received from the fourth means.

Also, the software rental system according to the second aspect of the present invention may be configured so that the fourth means, or means for obtaining the usage status information, obtains the information on the frequency at which each individual functional software component running on the client terminal in the client system is used, and the fifth means, or means for calculating the usage fee, calculates the usage fee for each component, based on the frequency information received from the fourth means.

The software rental system according to the first or second aspect of the present invention may be configured so that the fifth means, or means for calculating the usage fee, sends the accounting information to the appropriate client terminal in the client system over the network.

The software rental system according to the first or second aspect of the present invention may be configured so that the client terminal remains connected to the network while the user is using commercial software products or any of the individual functional software components included in a commercial software products on the client terminal in the client system.

In the software rental system according to the first or second aspect of the present invention, server system may be connected to the client system through a firewall that may be installed between the server system and client system and that only allow signals that conform to a particular communications protocol to pass through the firewall, and the server system may include a signal converting means for converting the signals that can flow through the server system into the signal format conforming to the said particular communications protocol, and converting the signals conforming to the said particular communications protocol into the signal format that can flow through the server system.

In the software rental system according to the first or second aspect of the present invention, a commercial software product that is rented to a client system may be installed on the client terminal in the client system with the first license manager incorporated into the said commercial software product, and a server system that offer the said commercial software product contains the second license manager, wherein the first license manager and the second license manager may communicate with each other through the Internet, and a firewall through which only the signals that conform to any particular communications protocol can be passed, and each of the client system and server system may include signal converting means for converting signals that can flow through the client system and server system respectively into the signal format conforming to the said particular communications protocol, and converting the signals conforming to the said particular communications protocol into respective signal format that can flow through the client system and server system respectively.

It should be noted that the signals that conform to the particular communications protocol may be signals that conform to a TCP/IP application protocol that can be passed through the firewall between the client system and the Internet and between the server system and the Internet.

In order to attain the above objects, a third aspect of the present invention is to provide a software rental method for allowing a server system including one or more server computers to offer commercial software products on the rental basis to one or more client systems connected to the said server system over a communication network, wherein the method comprises the five steps, including:

a first step of receiving, over the communication network, a request to use a commercial software product from a client terminal in a client system;

in response to the receipt of the request at said first step, a second step of authenticating the user on the client terminal in the client system by checking the identification information received with the request over the communication network;

after the user is authenticated at said second step, a third step of licensing the user to use the commercial software product;

a fourth step of obtaining, across the network, the usage status information for the software product licensed at said third step and running on the client terminal in the client system; and

a fifth step of for calculating the usage fee for the software product, based on the usage status information obtained at said fourth step, and charging the usage fee for the software product to the user.

In order to attain the above objects, a fourth aspect of the present invention is to provide a software rental method for allowing a server system including one or more server computers to offer commercial software products on the rental basis to one or more client systems connected to the said server system over a communication network, wherein the method comprises the five steps, including:

a first step of receiving, over the communication network, a request to use a commercial software product from a client terminal in a client system;

in response to the receipt of the request at said first step, a second step of authenticating the user on the client terminal in the client system by checking the identification information received with the request over the communication network;

after the user is authenticated at said second step, a third step of licensing the user to use the commercial software product;

a fourth step of obtaining, across the network, the usage time information for the software product licensed at said third step and running on the client terminal in the client system; and

a fifth step of for calculating the usage fee for the software product, based on the usage time information obtained at said fourth step, and charging the usage fee for the software product to the user.

In order to attain the above objects, a fifth aspect of the present invention is to provide a software rental method for allowing a server system including one or more server computers to offer commercial software products on the rental basis to one or more client systems connected to the said server system over a communication network, wherein each of the commercial software products includes a collection of individual functional software components and wherein the method comprises the five steps, including:

a first step of receiving, over the communication network, a request to use a commercial software product from a client terminal in the client system;

in response to the receipt of the request at said first step, a second step of authenticating the user on the client terminal in the client system by checking the identification information received with the request over the communication network;

after the user is authenticated at said second step, a third step of licensing the user to use each of the individual functional software components contained in the commercial software product;

a fourth step of obtaining, across the network, the usage status information for each of the individual functional software components licensed at said third step and running on the client terminal in the clint system; and

a fifth step of for calculating the usage fee for each individual functional software component, based on the usage status information obtained at said fourth step, and charging the usage fee for each individual functional software component to the user.

In order to attain the above objects, a sixth aspect of the present invention is to provide a software rental method for allowing a server system including one or more server computers to offer commercial software products on the rental basis to one or more client systems connected to the said server system over a communication network, wherein each of the commercial software products includes a collection of individual functional software components and wherein the method comprises the five steps, including:

a first step of receiving, over the communication network, a request to use a commercial software product from a client terminal in the client system;

in response to the receipt of the request at said first step, a second step of authenticating the user on the client terminal in the client system by checking the identification information received with the request over the communication network;

after the user is authenticated at said second step, a third step of licensing the user to use each of the individual functional software components contained in the commercial software product;

a fourth step of obtaining, across the network, the usage time information for each of the individual functional software components licensed at said third step and running on the client terminal in the client system; and

a fifth step of for calculating the usage fee for each individual functional software component, based on the usage time information obtained at said fourth step, and charging the usage fee for each individual functional software component to the user.

In order to attain the above objects, a seventh aspect of the present invention is to provide a computer program that is implemented by program code means for being executed on one or more computers on a software rental system that offers commercial software products to a plurality of client system on the rental basis over a communication network, each of the commercial software products comprising a collection of individual functional software components packaged into the product, wherein the program code means includes:

first program code means for receiving a request to use a commercial software product from each of client terminal in client systems over the communication network;

in response to the receipt of said request at said first program code means, second program code means for authenticating the user who submitted the request from said each client terminal in the client system over the communication network, by checking the identity information received with the request over the communication network;

after authenticating the identity of the user at said second program code means, third program code means for licensing the user on said client terminal in the client systems to use each of the individual functional components contained in the software product as requested;

fourth program code means for obtaining, from said each client terminal in the client systems and over the communication network, the usage status information for each of the individual functional components packaged into the software product and licensed by said third program code means, said usage status information reflecting the actual use of each individual functional component at said each client terminal in the client systems; and

fifth program code means for calculating the usage fee for each individual functional component, based on the usage status information obtained by said fourth program code means.

In order to attain the above objects, an eighth aspect of the present invention is to provide a computer program that is implemented by program code means for being executed on one or more computers on a software rental system that offers commercial software products to a plurality of client systems on the rental basis over a communication network, wherein the program code means includes:

first program code means for converting received signals from the signals that conform to the TCP/IP application protocol that specifies the particular protocol type and particular TCP message port number in the IP header, into the signal format that is adequate for communication within the signal receiving system, and for converting transmitting signals from the signal format that is adequate for communication within the signal transmitting system, into the signal format that conforms to the TCP/IP application protocol that specifies the particular protocol type and particular TCP message port number in the IP header,;

second program code means for receiving a request to use a software product from each of client terminal in client systems over the communication network;

in response to the receipt of said request at said second program code means, third program code means for authenticating the user who submitted the request from said client terminal in the client system over the communication network, by checking the identification information received with the request over the communication network;

after the user is authenticated by said third program code means, fourth program code means for licensing the user on said client terminal in the client systems to use the software product as requested;

fifth program code means for obtaining, from said client terminal in the client systems, the usage status information for the software product licensed by said fourth program code means, said usage status information reflecting the actual use of the software product running on said client terminal in the client systems; and

sixth program code means for calculating the usage fee for the software product, based on the usage status information obtained by said fifth program code means.

In order to attain the above objects, a ninth aspect of the present invention is to provide a computer program that is implemented by program code means for being executed on one or more computers on a software rental system that offers commercial software products to a plurality of client systems on the rental basis over a communication network, wherein each of the commercial software products includes a collection of individual functional software components and wherein the program code means includes:

first program code means for converting received signals from the signals that conform to the TCP/IP application protocol that specifies the particular protocol type and particular TCP message port number in the IP header, into the signal format that is adequate for communication within the signal receiving system, and for converting transmitting signals from the signal format that is adequate for communication within the signal transmitting system, into the signal format that conforms to the TCP/IP application protocol that specifies the particular protocol type and particular TCP message port number in the IP header,;

second program code means for receiving a request to use a software product from each of client terminal in the client system over the communication network;

in response to the receipt of said request by said second program code means, third program code means for authenticating the user who submitted the request from said client terminal in the client system over the communication network, by checking the identification information received with the request over the communication network;

after the user is authenticated by said third program code means, fourth program code means for licensing the user on said client terminal in the client systems to use each of the individual functional software components contained in the software product as requested;

fifth program code means for obtaining, from said client terminal in the client systems, the usage status information for each individual functional software component licensed by said fourth program code means, said usage status information reflecting the actual use of each software component running on said client terminal in the client systems; and

sixth program code means for calculating the usage fee for each software component, based on the usage status information obtained by said fifth program code means.

According to the present invention, the usage status information for a particular commercial software product that is offered on the rental basis over the communication network may be obtained on each individual software component basis. Thus, a variety of useful information may be derived from this usage status information, which may also be used as the basis for calculating the accounting information such as the usage fee for each individual software component.

It may be appreciated that users don't have to purchase any expensive software products, and can select any required software component from the software product and use the selected software component as many times as the users wish to run it. In addition, the users can have the latest version of the software component running on their client terminals as the project progresses. Thus, the cost and labor required to maintain the software products and update them to new versions may be reduced, and the cost and labor required to develop new products may be reduced.

On the ASP vendor side, the usage status information may be used to obtain the useful statistical data, and may also be used as the basis to develop a new software product, for example. This information may also be useful when ASP advises the user as to how the user could use the software properly.

According to the present invention, the time information may be obtained for each of the individual functional components contained in a particular software product. This time information may show how many hours the user has been running each individual component on the client terminal. The accounting information may be derived from the time information, and the usage fee may be charged to the user. The time information that contains more specific data items may also be obtained. For example, those data items may include the name of the user, the name of the software component used by the user, the purpose for which the software component is used, the location where the software component is used, and the time duration during which the software component has been used. This information may be used for the various analytical purposes.

According to the present invention, the information may be obtained, which shows the number of times (frequency) at which a particular software component has been used. This information may be used as the basis for the accounting information, from which the usage fee may be charged to the user. This information may also contain more specific data items, such as the name of the user, the name of the software component used by the user, the purpose for which the software component is used, the location where the software component is used, and the number of times at which the software component has been used. This information may be used for the various analytical purposes.

According to the present invention, the user that uses a particular software component on the client terminal may be authenticated by the server over the communication network, and the usage status information for a particular software product may be logged on the server over the communication network. Thus, the present invention allows for the collective and centralized management of multiple users, making it easier to keep track of the usage status for each software component used by each user.

Furthermore, according to the present invention, in the software rental system that operates across a communication network such as the Internet, the system may be configured to include a client system that includes a client's terminal on which a commercial software product being rented resides, the said software product containing a first license manager, a server system that includes a server computer on which a second license manager is installed, and a firewall installed between the client system and server system interconnected across the Internet, the said firewall only allowing the signals that conform to a particular communications protocol to flow through the said firewall. The software rental system of the present invention can keep track of the usage status of the rented commercial software product, and calculate the usage fee for the software product, by allowing the first license manager and second license manager to communicate with each other so that the communications between the first and second license managers can occur along the communication route that is transparent to the license managers and as if the license managers reside in the same LAN.

### BERIEF DESCRIPTION OF THE DRAWINGS

FIG. 1 illustrates an exemplary configuration of the software rental system according to one embodiment of the present invention;

FIG. 2 represents one example of the interrelationships among the hardware and software components of the software rental system according to one embodiment of the present invention;

FIG. 3 illustrates a process for manipulating and creating different types of data from the records in the authentication log and vendor log;

FIG. 4 represents one example of the listing that a vendor can access and reference online, describing the information on the usage status for each of the individual functional components of a particular commercial software product;

FIG. 5 represents one example of the listing that an end user can access and reference online, describing the information on the usage status for each of the individual functional components of a particular commercial software product;

FIG. 6 represents one example of the listing that describes the general information on some individual functional components of a particular commercial software product according to the purpose for which the components are used;

FIG. 7 represents one example of the listing that describes the information on some individual functional components of a particular commercial software product according to the purpose for which the components are used by each customer;

FIG. 8 represents one example of the listing that describes the information on some individual functional components of a particular commercial software product by category;

FIG. 9 represents one example of the usage status analysis report that describes the information on some individual functional components of a particular commercial software product according to the purpose for which the components are used;

FIG. 10 (a) represents one example of the listing that describes the customer classification information for individual customers;

FIG. 10 (b) represents one example of the listing that describes the customer classification information for corporate customers;

FIG. 11 represents one example of the listing that describes the marketing information for each vendor;

FIG. 12 represents one example of the report that may be used to determine the marketability of a particular commercial software product;

FIG. 13 represents one example of the listing that describes the current configuration date for a particular commercial software product;

FIG. 14 represents one example of the listing that shows the data for the critical item parameters;

FIG. 15 represents one example of the listing that describes the usage status data for a particular user;

FIG. 16 represents one example of the analysis report that describes the recommended optimum component configuration;

FIG. 17 is a block diagram illustrating one form of the communication network that may be employed in the software rental system according to one embodiment of the present invention;

FIG. 18 is a block diagram of the request process, illustrating how a request may be submitted from the license manager in the client system to the license manager in the server system through the communication network shown in FIG. 17;

FIG. 19 is a block diagram of the response process, illustrating how a response may be sent from the license manager in the server system to the license manager in the client system through the communication network shown in FIG. 17;

FIG. 20 is a block diagram illustrating how the protocol conversion occurs during the request process, when a request is submitted as shown in FIG. 18;

FIG. 21 is a block diagram illustrating how the protocol conversion occurs during the response process, when a response is sent back as shown in FIG. 19.

### DETAILED DESCRIPTION OF PREFERRED EMBODIMENTS

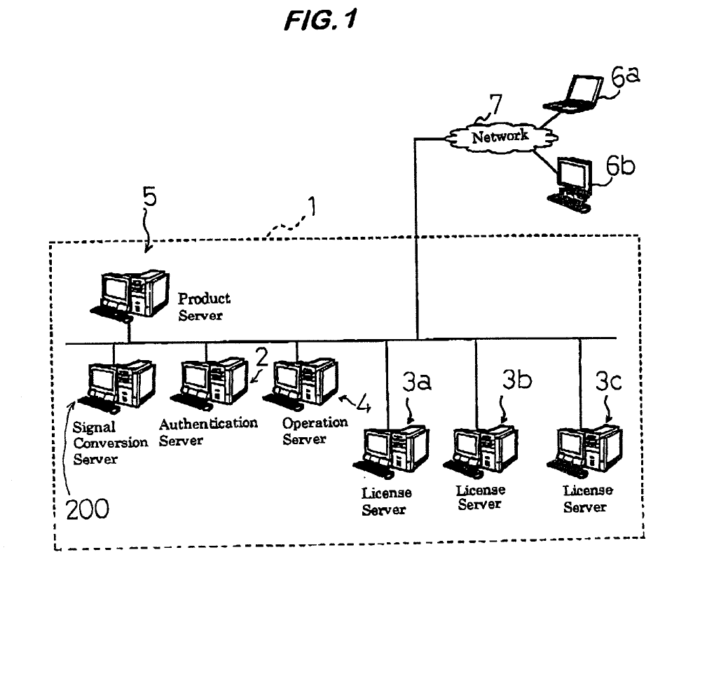

Referring now to FIGS. 1 through 21, several preferred embodiments of the present invention are described in further detail.

FIG. 1 illustrates the basic configuration of the software rental system according to the present invention.

In the embodiment shown in FIG. 1, the software rental system of the present invention is represented by a server system 1 that may be installed on an application service provider (which will be referred to simply to “ASP” hereinafter) to allow the ASP to offer commercial software products on the rental basis. The server system 1 is connected to one or more user's client systems through a network 7. In the embodiment shown in FIG. 1, client systems are comprised by user's client terminals 6a, 6b, 6c, etc, each of which is represented by a computer such as a personal computer. Alternatively, client terminals 6a, 6b, 6c, etc, are normally connected to a local area network (LAN) that is installed within the user's premoses, so that, client system can be comprised by the said LAN.

The ASP offers a commercial software product to a user by licensing the user to use the software product and charging the user for the use of the software product. In this case, the commercial software product usually includes a collection of individual functional software components packaged into the product, and will be referred to simply as “software product” in the following description as well as in the accompanying drawings.

The server system 1 on the ASP includes an authentication server 2, license servers 3a, 3b, etc. each assigned to each user, an operation server 4 and a software product server 5, which are interconnected via a LAN (local area network). The authentication server 2 has two roles. One is to receive a request to use a particular software product from a user, and the other is to authenticate the request. The license server 3a is responsible for licensing the user to use the software product requested, and collecting the usage status information for the licensed software product that is running on the client system or client terminal in the client system. The operation server 4 is responsible for charging the user for the use of the software product.

The operation of the server system 1 may be summarized as follows.

Each of the client terminals 6a, 6b, etc., each comprising client system, has a software product installed thereon. The user on each client system is not permitted to use the software product installed on the terminal. In order to use the software product, the user must be identified and authenticated by the authentication server 2 that resides on the software rental system. This occurs via the network 7.

In the software rental system of the present invention, the user remains connected to the communication lines across the network 7 while the user is running the software product. The time at which the user activates a particular software component in the software product and the time at which the user terminates the software product may be logged on the appropriate license server 3a, 3b, etc. Each client terminal 6a, 6b, etc., that comprising client system, corresponds to each license server 3a, 3b, etc., as described above.

ASP may calculate the usage fee for the software component, based on the times at which the software component is activated and terminated and that are logged on the appropriate license server 3a, 3b, etc. This process may be performed for each software component that is running on the client system or client terminal in the client system.

The customers of the ASP may include end users and vendors. For end users, ASP may supply, on the rental basis, a commercial software product to an end user upon request. For vendors, ASP may supply, on the rental basis, a commercial software product to a customer of a vendor upon request. ASP may gather the usage status information for each of the software components in the rented software product that are actually running on the end user's system or terminal in the system, process the information, and deliver the result to the vendor. ASP may also collect, on behalf of the vendor, the usage fee for each software component that is running on the end user' system or terminal in the system.

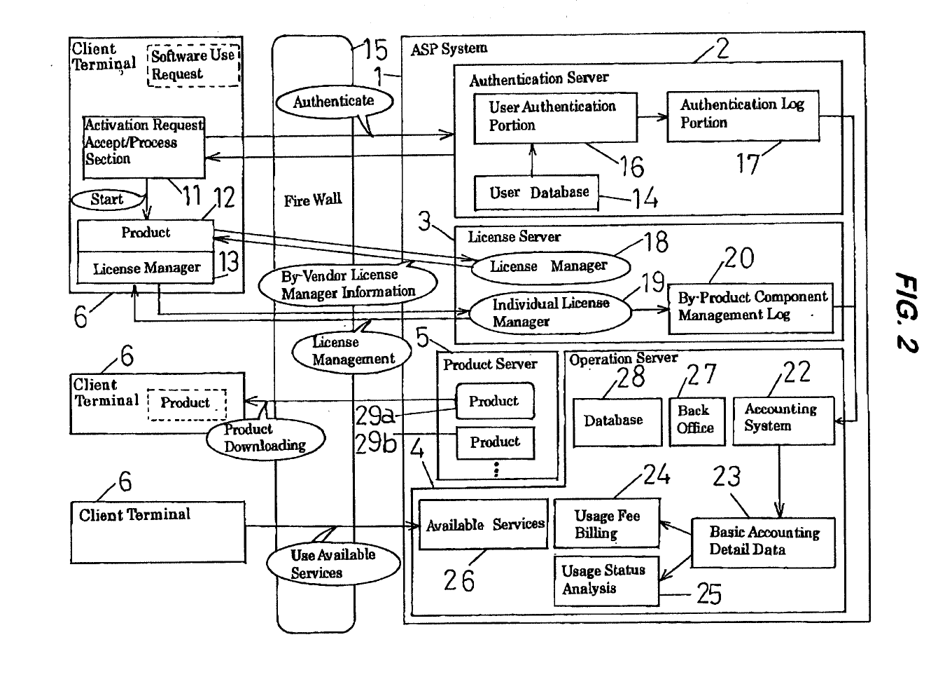

FIG. 2 illustrates the interrelationships among the hardware and software components of the software rental system shown in FIG. 1.

The client terminal, generally identified by 6a and comprising client system in this embodiment, that contains a computer such as a personal computer includes an activation request accepting and processing section 11, a commercial software product 12 now installed but not licensed, and a license manager 13. It also contains an appropriate OS (operating system) and a communication program that allows the user to communicate with ASP, although they are not shown.

The activation request accepting and processing section 11 may be activated when the user clicks on the appropriate icon on the user's terminal screen by using a mouse, or enters the appropriate command on the command line on the terminal screen. When the activation request accepting and processing section 11 is activated, the client terminal 6a is then connected with ASP over the communication lines, making the client terminal 6a ready to communicate with an ASP. Then, the user may enter the required information such as his or her user name and password number on the client terminal 6a. The information that has been entered is passed to the activation request accepting and processing section 11, which sends it to the authentication server 2 that resides on the ASP.

The commercial software product 12 that is installed on the client terminal 6a represents an application program, for example, that may be used in the electronic circuit designing application. This application program is stored on the hard (fixed) disk within the client terminal 6a, and may be activated by the activation request accept and processing section 11 after the product 12 is authenticated by the license server 2.

Examples of the commercial software product that are offered by the software rental system may include various application programs, such as the industrial design, computer graphics, financial and accounting software, word processing software, and game software that are generally known as the popular software. Other application programs may be included, such as the electronic circuit design CAD software, machinery design CAD software, and architectural building CAD software, which are known as the computer-aided design software. There are also the highly specialized or academic scientific software products (such as the software for calculating the interaction between the electromagnetic fields distributed on the 3-D plane and the electron beams, the software for determining the crystalline structure from the distribution of the diffraction light that is produced when a monocrystalline is exposed to X-ray beams, the software for forecasting the weather by solving a given complex equation based on the climate data, and the software for predicting the stock prices on the stock exchange market based on the theory of the probability.

In the embodiment that is described below, it is assumed that, by way of example, the software product 12 is represented by the electronic circuit design CAD software.

It is noted that the software product 12 represented by the CAD software comprises a collection of individual functional components that allow the user to supply the circuit diagram input, to supply the signal waveform input, to edit those inputs, to simulate the circuit, and the like.

The product 12 has the license manager 13 embedded therein, which may allow the client terminal 6a to communicate with the license server 3 installed on the appropriate ASP, while the product 12 is running on the client terminal 6a.

For example, when the user on the client terminal 6a activates a particular software component, the license manager 13 sends the type of the component and the time at which it is activated to the license server 3. The user alone cannot run the product 12, and can only run it under the supervision of the license server 3 that communicates with the license manager 13.

Occasionally, the license manager 13 may have the health check by the license server 3 through the network. This health check is made to see the running conditions of the product 12, such as whether it is running properly or whether there is any problem with it.

The server system 1 on the ASP includes various servers, which will be described below.

The authentication server 2 includes a user database 14, a user authentication section 16, and an authentication log 17. The user database 14 may contain user data, such as the name of each user, the user ID of each user, and the password number of each user. The user authenticating section 16 may be operated to authenticate the user, when an activation request is received from the activation request accepting and processing section 11 on the client terminal 6a. The authentication log 17 may record the activities that occur on the user authentication section 16.

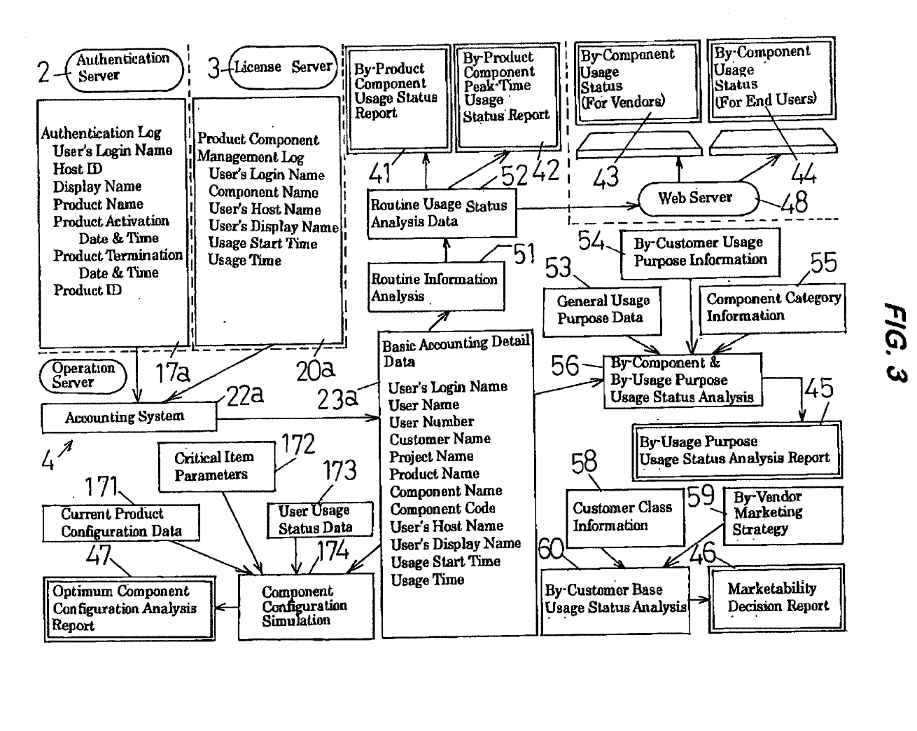

The user authentication section 16 may check the data in the activation request against the data stored on the user database 14, and may authenticate the user by determining the identity of the user. The authentication log 17 includes an authentication log 17a (FIG. 3) on which the information on each user and each product is recorded, and at the end of the authentication process, the user authentication section 16 may record the log 17a for the user and product onto the authentication log 17.

As shown in FIG. 3, the authentication log 17a contains entries, such as “user's login name”, “host ID”, “display name”, “product name”, “the date and time of the product activation”, “the date and time of the product termination”, and “product ID”.

The license server 3 (FIG. 2) includes a license manager 18, an individual license manager 19, and an individual product component management log 20.

One license manager 18 resides on each license server 3. When a product 12 is activated on a client terminal 6a, the license manager 13 on the client terminal 6a begins to communicate with the license manager 18 on the appropriate license server 3. Then, the license manager 18 determines the type of the activated product 12, and send the information in the license file to the license manager 13. This license file information contains the licensing information for each software components of the product 12.

The individual license manager 19 receives the license file information from the license manager 13 on the client terminal 6a, checks it, and may license the use of each individual software component of the product 12.

The individual license manager 19 may record, on the product component management log 20, the history of activities each time each licensed component of the product 12 is activated and terminated.

The product component management log 20a shown in FIG. 3 contains entries, such as “user's login name”, “component name”, “host name”, “display name”, “activation time”, and “running time”. The “activation time” may be in terms of the date and time of the day (hh:mm) on which the software component is activated. The “running time” may be expressed in terms of the hours and minutes during which the component is running.

The operation server 4 shown in FIG. 2 includes an accounting section 22. This accounting section 22 is coupled to the authentication log 17 and to the product component management log 20, and may receive the authentication log 17a from the authentication log 17, and the product component management log 20a from the product component management log 20.

The accounting section 22 may compare the two logs 17a and 20a by using the “user's login name” in the respective logs as a key, and may provide the basic accounting detail data 23a as shown in FIG. 3 to a basic accounting detail data section 23.

The basic accounting detail data 23a includes “user's login name”, “user name”, “user number”, “customer name”, “project name”, “product name”, “component name”, “host name”, “display name”, “activation time”, “running time”, and so on.

As shown in FIG. 2, the operation server 4 further includes a usage fee charging section 24, a usage-status analyzing section 15, and a service offering section 26. The usage fee charging section 24 may calculate the usage fee for each component used by each user, based upon the basic accounting detail data 23 from the section 23, and may provide the specific billing information. The ASP may use this billing information to produce a billing note, which may be sent by mail to the appropriate user. This billing note may also be sent online through the network (such as the Internet).

The usage-status analyzing section 25 analyzes and process the data 23a received from the basic accounting detail data section 23, and generates the accounting information that will be supplied to the end user and to the vendor. In this embodiment, the specific usage status information for each software component may be accumulated as the basic accounting detail data 23a, which may be analyzed to provide the useful data for the end user and vendor.

The service section 26 may derive various kinds of information from the basic accounting detail data 23a, and provide this information to the client terminal 6a. Such information may include, for example, the usage status for the current month, the usage fees that change from month to month, and the types of the components that are being used as the project goes on.

The operation server 4 further includes a database 28 and a back office 27. The database 28 may store the data relating to the products and customers. This data may include each product name and code, each component name and code in the product, each vendor name and code, the user name and number for the product, and each customer name, code and class. The back office 27 may perform miscellaneous tasks required to operate the operation server 4.

The product server 5 contains different commercial software products, which may be downloaded to the user's client terminal 6a. Those software products may be delivered to the user in the form of any suitable storage medium, such as CD-ROM, floppy disk, magnetic tape, and optical magnetic disk, if the user desires so.

FIG. 3 illustrates the flow of data that may be passed from the authentication log 17a and product component management log 20a to the usage-status analyzing section 25 in the operation server4 where the necessary information may be provided to the end user and vendor.

Specifically, the usage-status analyzing section 25 may provide various reports, such as a product component usage status report 41, a product component peak-time usage status report 42, a by-purpose usage status analysis report 45, a marketability decision report 46, and a optimal component configuration analysis report 47, from the basic accounting detail data 23a and the data stored on the database 28.

As described earlier, the authentication log 17a that resides on the authentication server 2 may be compared against the product component management log 20a that resides on the license server 3 by the accounting system section 22 on the operation server 4, which may provide the resulting basic accounting detail data 23a.

The client terminals 6a, 6b, 6c, etc, are normally connected to a local area network (LAN) that is installed within the customer premises. A firewall 15 may be installed between the LAN and the Internet, as shown in FIG. 2. Although not shown, the server system 1 on the ASP may be connected to the Internet through the firewall. It may be apparent to any person skilled in the art that the firewall 15 may act to protect the computer system within the office from any illegal invasion or attack from the outside, by restricting the communications between the computer in the office and other communication devices connected to the Internet.

In the software rental system according to the present invention, all commercial software products that are offered on the rental basis are installed on client terminals 6a, 6b, 6c, etc, that comprising each client system or that included in the client system 6, with the license manager 13 being embedded in each of the products. The license manager 13 may communicate with the corresponding license manager 18 or individual license manager 19 that resides on the respective license servers 3a, 3b, and 3c. The user on the client system 6 may be allowed to use the product 12 under the supervision of the appropriate license server 3a, 3b, and 3c.

The license manager 13, license manager 18 and individual license manager 19 may normally reside on the same LAN, over which they may communicate with each other. It is noted, however, that when they are interconnected via the Internet, and the firewall 15 is installed between the LAN and the Internet to only allow the signals conforming to a particular communication protocol to pass through the firewall, the license manager 13, license manager 18 and individual license manager 19 cannot communicate with each other under the normal conditions.

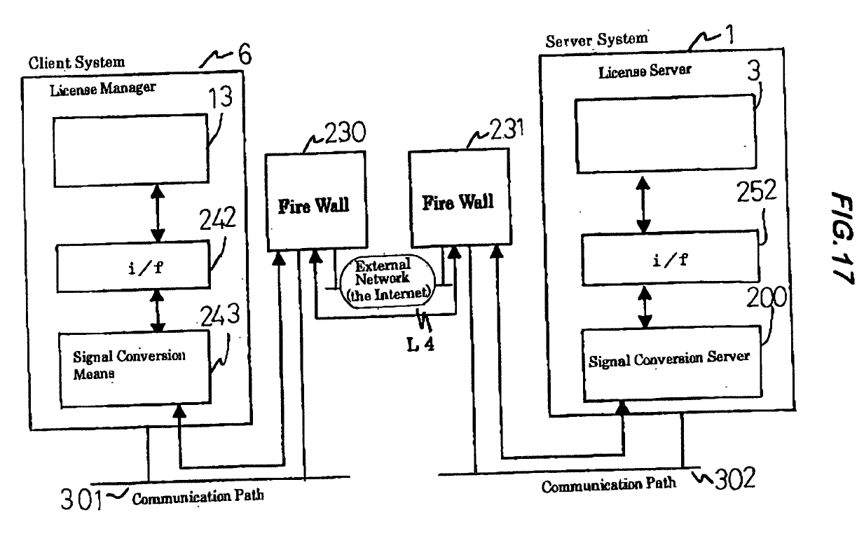

In order to permit such communications, the software rental system according to the present invention is configured to include the following functions or hardware means that will be described by referring to FIGS. 17 through 21.

The server system 1 on the ASP includes a signal conversion server 200, as shown in FIG. 1. The signal conversion server 200 can communicate with each of the license servers 3a, 3b, 3c on the LAN 302. In FIG. 1, reference numeral 252 represents an interface within the signal conversion server 200.

The signal conversion server 200 may convert the signals that can flow within the LAN 302 into the signal format that conforms to the particular communication protocol that allows the signals to pass through the firewalls 231, 230, and may also convert the signals passed through the firewalls 231, 230 into the signal format that allows the signals to flow within the LAN 302.

On the other hand, the client system 6 includes a signal conversion means 243 that can communicate with the license manager 13 via an interface 242. The signal conversion means 243 performs the similar functions to the signal conversion server 200, that is, may convert the signals that can flow within the client system 6 into the signal format that conforms to the particular communication protocol that allows the signals to pass through the firewalls 231, 230, and convert the signals passed through the firewalls 231, 230 into the signal format that allows the signals to flow within the client system 6.

In the illustrative embodiment, it is assumed that the firewalls 231, 230 may only allow those signals that conform to the predetermined, particular TCP/IP application protocol to pass through them. Thus, the signal conversion server 200 and the signal conversion means 243 may convert the respective signals occurring on the LAN 302 and within the client system 6 into the signal format that conforms to that said particular TCP/IP application protocol, and may convert the signals that conform to the said particular TCP/IP application protocol into the respective signal format that allows the signals to flow within the LAN 302 and within the client system 6, respectively.

The license manager 13 within the client system 6 may communicate with the corresponding license manager 18 or individual license manager 19 on the server system 1 via the signal conversion means 243. Then, the signals that occur within the client system 6 may be converted by the signal conversion means 243 into the signal format that conform to the said particular TCP/IP application protocol that allows the signals to pass through the firewalls 231, 230. The converted signals may then be passed to the firewall 230, through which the signals may be passed over the Internet L4 to the signal conversion server 200 on the server system 1, where the signals may be converted into the signal format that allows the signals to flow within the LAN 302, and the signals may be passed to the license servers 3a, 3b, 3c.

It is noted that each of the license servers 3a, 3b and 3c may contain a communication program that allows the license server to communicate on the LAN, and to communicate with the license manager 13 on the client system 6 through the firewalls 231, 230 and the Internet L4.

Similarly, the license manager 13 on the client system 6 may contain a communication program that communicates with the signal conversion means 243 within the client system, and allows the license manager 13 to communicate with the license servers 3a, 3b, 3c on the server system 1 through the firewalls 231, 230 and the Internet L4.

In the software rental system according to the present invention, the interactions that occur between the client system 6 and the server system 1 on the ASP have the communication form that allows the communications to allow through the firewall 15 (FIG. 2), as described in connection with FIG. 17, but may have other different forms of communications.

For example, the signal conversion server 200 on the server system 1 may not have to reside on a different terminal from the license servers 3a, 3b, 3c on the LAN 302, and each of the license servers 3a, 3b, 3c may include the signal conversion means that provides the equivalent signal conversion functions of the signal conversion means 243. Similarly, the signal conversion means 243 on the client system 6 may not have to reside on the same terminal 6a on which the product 12 containing the license manager 13 is installed.

For example, a plural client terminals such as client terminals 6a, 6b, 6c, etc, are connected to user's LAN 301, in which the product 12 containing the license manager is installed on client terminal 6a, and the client terminal 6b, may include the signal conversion mean that provides the equivalent signal conversion functions of the signal conversion means 200 in the server system 1.

The client system and the server system 1 may not have to be a computer system, and may be a device that includes a central processing unit (CPU) that implements the intelligent functions.

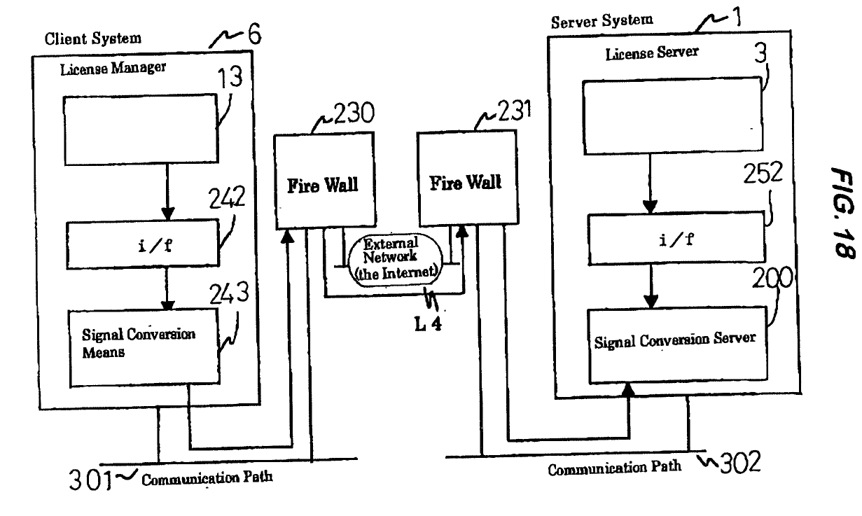

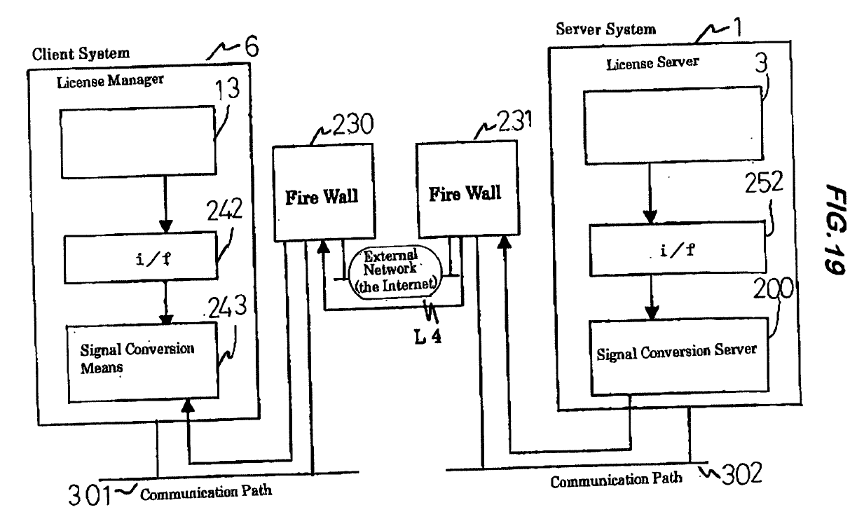

Next, the operations that are performed in the communication configuration shown in FIG. 17 are described by referring to FIGS. 18 and 19.

FIG. 18 shows the flow of request signals from the license manager 13 on the client system 6 to the license server 3 on the server system 1 when the request operation is performed. The license manager 13 may communicate with the signal conversion means 243 within the client system 6, and the signal conversion means 243 may convert the signals that occur within the client system 6 into the signal format that conforms to the particular TCP/IP application protocol and allows the signals to pass through the firewalls 230, 231. Upon receiving the signals from the signal conversion means 243, the signal conversion server 200 on the server system 1 may convert the received signals into the signal format that allows the signals to flow through the LAN 302, and may communicate with the license manager 18 or individual license manager 19 within the license server 3.

FIG. 19 shows the flow of response signals from the license manager 18 or individual license manager 19 within the license server 3 to the license manager 13 within the client system 6 when the response operation is performed. The response signals that are generated in response to the request signals from the license manager 13 on the client system 6 may be converted by the signal conversion server 200 on the server system 1 into the signal format that conforms to the particular TCP/IP application protocol and allows the signals to pass through the firewalls 230, 231. The response signals may be returned to the signal conversion means 243 within the client system 6, which may convert the received response signals into the signal format that allows the signals to flow within the client system 6, and the signals may be returned to the license manager 13.

The sequence of the operations described above enables the license manager 13 within the client system 6 and the license manager 18 or individual license manager 19 within the license server 3 on the server system 1 to communicate with each other, without having to care about the communication routes, which are transparent to them.

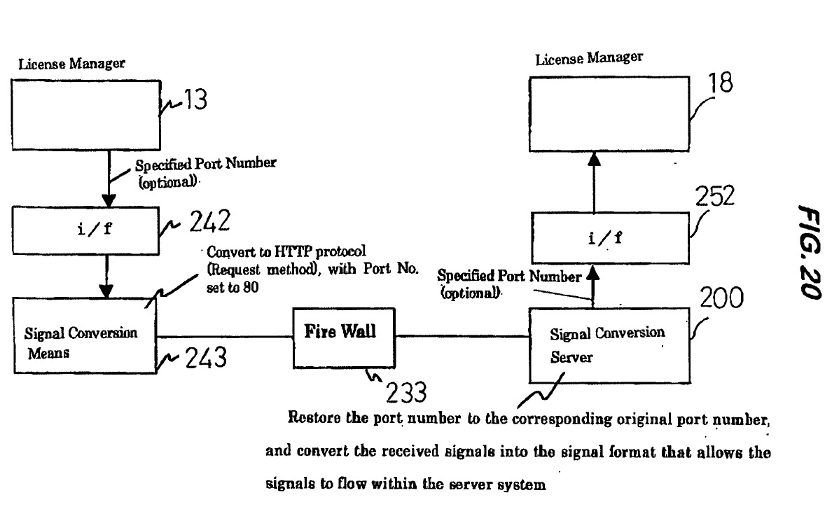

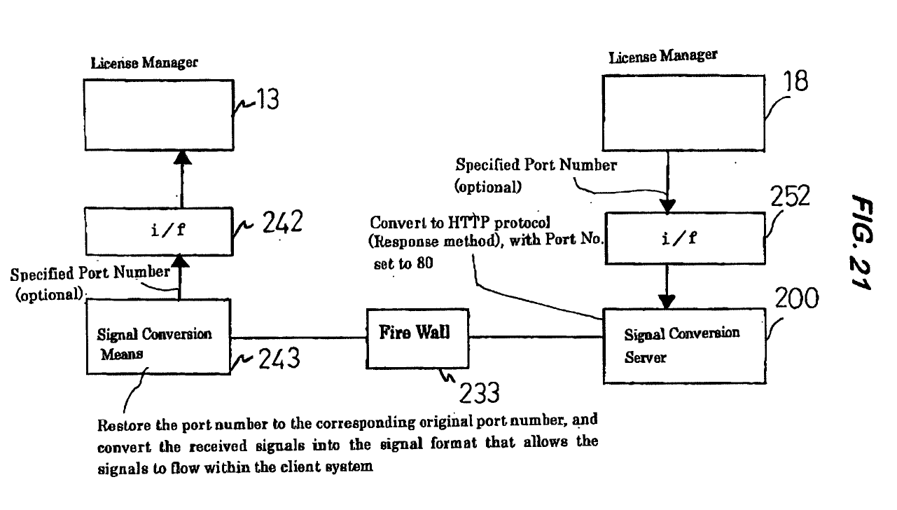

FIGS. 20 and 21 show the signal conversion process that occurs on the client system 6 and the server system 1, respectively.

FIG. 20 describes the protocol conversion process that occurs on the client system 6 and the server system 1, when a request is made from the license manager 13 on the client system 6 to the license manager 18 or individual license manager 19 on the server system 1. The license manager 13 on the client system 6 may specify any port number, which is provided to the signal conversion means 243 in that client system 6. Then, the signal conversion means 243 may convert this port number into the TCP/IP port number, i.e., port number 80, that is acceptable to the firewall 233, and may convert the signals into the IP header protocol signals (e.g., any particular HTTP protocol signals) that are acceptable to the firewall 233. Then, the converted signals may be used to generate a connection request to be sent to the firewall 233. Upon receiving the HTTP protocol signals, the signal conversion server 200 on the server system 1 may convert the signals into the signal format that allows the signals to flow through the LAN 302, and the signals may be passed to the license manager 18 or individual license manager 19 within the license server 3.

FIG. 21 describes the protocol conversion process that occurs on the client system 6 and the server system 1, when a response is sent from the license manager 18 or individual license manager 19 within the license server 3 on the server system 1 to the license manager 13 on the client system. The license manager 18 or individual license manager 19 within the license server 3 on the server system 1 may perform the same operations as when the communications occur through the LAN 302, and may specify any port number, which is provided to the signal conversion server 200. Then, the signal conversion server 200 may convert this port number into the TCP/IP port number, i.e., port number 80, that is acceptable to the firewall 233, and may convert the signals into the IP header protocol signals (e.g., any particular HTTP protocol signals) that are acceptable to the firewall 233. Then, the converted signals may be used to generate a response to be sent to the firewall 233. Upon receiving the HTTP protocol signals, the signal conversion means 243 on the client system 6 may restore the port number to the corresponding original port number, and may convert the received signals into the signal format that allows the signals to flow within the client system 6. The signals may be passed back to the license manager 13.

Referring now to FIGS. 3 through 16, the operation of the usage-status analyzing section 25 is described.

The usage-status analyzing section 25 includes a routine information analyzing sub-section 51, which may analyze the information, such as the usage time, usage time zone and user for each software component in a particular product that is actually used, that is derived from the basic accounting detail data 23a, and may provide a routine usage status analysis data 52.

The usage-status analyzing section 25 may generate a product component usage status report 41 and a product component peak-time usage status report 42, based on the routine usage status analysis data 52 from the routine information analyzing sub-section 51.

The product component usage status report 41 presents the usage status for each product, that is, indicates when and how each software component in each product has been used. This report may be utilized by both the vendor and end user.

The product component peak-time usage status report 42 presents how any product, or any software component thereof, that has been used intensively may be changing over time. This report may be utilized primarily by the end user. This report may help the end user to identify the product or component that has been used intensively at any particular stage of the project under way. As this report provides the useful information, which may be helpful when the end user negotiates with the ASP in order to enter an licensing agreement with the ASP as regards a particular software component.

The vendor or end user may have access to the routine usage status analysis data 52 through the Web server 48 (FIG. 3).

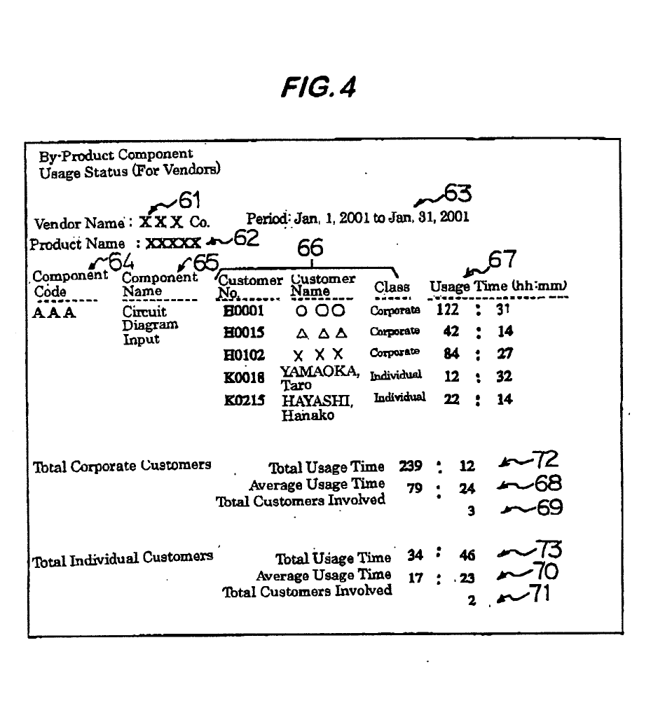

FIG. 4 represents an example of the component usage status information 43 for the vendor that may be displayed on the vendor's terminal. The component usage status information 43 includes the following fields or columns.

The “Vendor Name” column 61 indicates the name of the vendor associated with the component being used. As a rule, this vendor is only allowed to see the data associated with the customers belonging to the vendor.

The “Product Name” column 62 indicates the name of the product being analyzed. This product name may be selected from the list of the products that the vendor deals with. The “Time Interval” column 63 indicates the period of the time during which the product is being analyzed. The vendor may optionally specify this period.

The “Component Code” column 64 indicates the component codes of the components included in the product that is displayed in the “product name” column 62. The “Component Name” column 65 indicates the name of the component that corresponds to the component code displayed on the “Component Code” column 64, such as “circuit diagram input” and “simulation”.

The “Customer” column 66 indicates a listing of the vendor's customers classified by corporation and by individual. The customer listing consists of the uniquely assigned customer numbers, the customer names, and the type of the customer (corporation or individual).

The “Usage Time” column 67 indicates the total usage time of the particular component that has been used by each customer during the period indicated in the “Time Interval” column. It also includes the total usage time 72, 73 and average usage time 68, 70 for each corporation and each individual, and the number of the customers 69, 71 who used the component.

The information for the components of a particular product may be displayed in the above columns by selecting one or more components or all components.

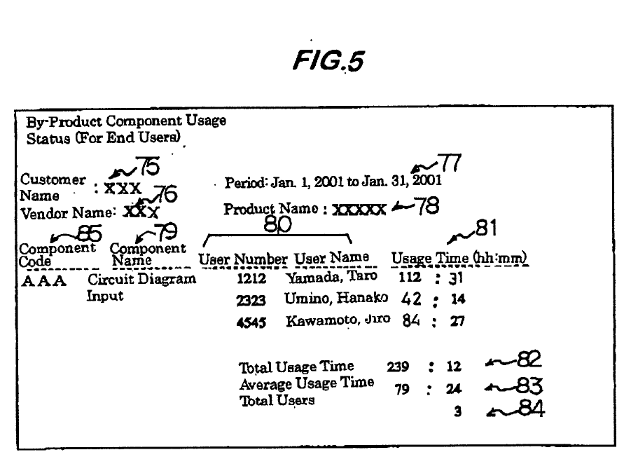

FIG. 5 represents an example of the component usage status information 44 for the end user that may be displayed on the end user's terminal. The component usage status information 44 includes the following fields or columns.

The “Customer Name” column 75 indicates the name of the particular customer. As a rule, the customer is only allowed to reference its own data. The “Vendor Name” column 76 indicates the name of the vendor who allows the customer to use the component under the licensing agreement. The “Time Interval” column 77 indicates the period of time during which the usage status is analyzed. The end user may optionally specify this time interval.

The “Product Name” column 78, the “Component Code” column 85, and the “Component Name” column 79 indicate the same information as for the “Product Name” column 62, the “Component Code” column 64, and the “Component Name” column 65, respectively. The “User” column 80 includes the user number and the user name, and indicates the user who uses the product indicated in the “Product Name” column 78.

The “Usage Time” column 81 indicates the amount of the time during each of the users indicated in the “User” column 80 has used the component indicated in the “Component Code” column 85.

The “Total Usage Time” column 82, the “Average Usage Time” column 83, and the “Number of Users” column 84 indicate the total time and average time for the component indicated in the “Component Code” column 85 that has been used by the users indicated in the “User” column 80, and the number of the users that have used that component, respectively.

The information for the components may be displayed in the above columns by selecting one or more components or all components.

The usage-status analyzing section 25 further includes a by-component/by-usage purpose usage-status analyzing sub-section 56 that analyzes the usage status for each component and for each usage purpose, as shown in FIG. 3.

The by-component/by-usage purpose usage status analyzing subsection 56 may generate a by-usage purpose usage status analysis report 45 by analyzing the usage status for each component and for each usage purpose, based on the basic accounting detail data 23a, the general usage purpose data 53, the by-customer/by-usage purpose information 54, and the component category information 55.

This report may be used together with the end user's purpose information to determine whether the current product is being utilized in the optimal manner. This analysis is usually performed by the ASP, who may advise the end user about using the product, based on the results of the analysis.

The general usage purpose data 53, the by-customer/by-usage purpose information 54, and the component category information 55 may be provided by the back office 27 from the data stored in the database 28.

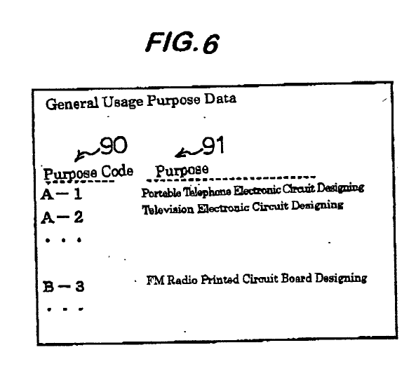

FIG. 6 represents an example of the general usage purpose data 53 in the table form. The general usage purpose data 53 indicates the purpose for which the product is used.

The general usage purpose data 53 includes a purpose code 90 and a purpose 91. The usage purpose 91 may represent the purpose for which a particular software product is used, such as the portable telephone electronic circuit design application, and the FM radio printed circuit board design application. The usage purpose code 90 may represent the code that identifies the usage purpose 91.

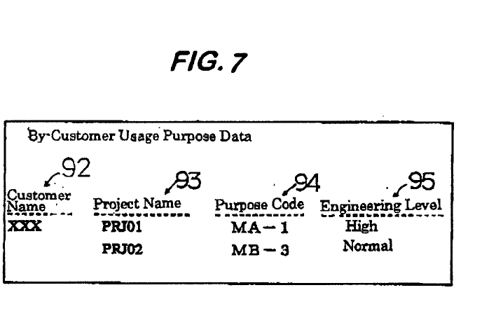

FIG. 7 represents an example of the by-customer/by-usage purpose information 54 in the table form. The by-customer/by-usage purpose information 54 identifies the specific usage purpose for which the product is used for each customer and for each project.

The by-customer/by-usage purpose information 54 includes the customer name 92, the project name 93, and the usage purpose code 94, and the engineering level 95. The customer name 92 represents the name of the ASP's customer, and the project name 93 represents the name of the project under which the product is used by the customer. The usage purpose code 94 represents the code to identify the project's purpose.

It should be noted that the usage purpose code 94 may previously be defined for each usage purpose. The engineering level 95 identifies the engineering level of the current product that is running on the customer computer, such as “High”, “Medium”, and “Low”.

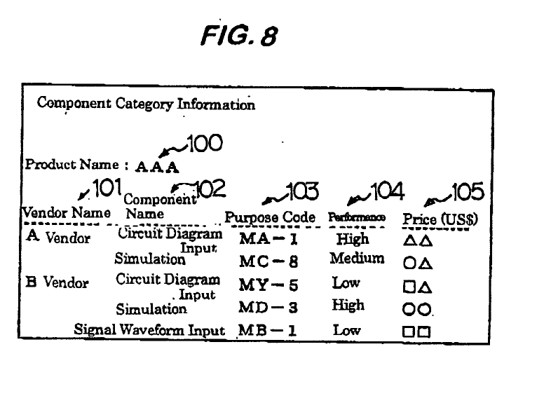

FIG. 8 represents an example of the component category information 55 in the table form. This data may represent the usage purpose of each component in the product and any other ancillary information.

The component category information 55 may include the product name 100, the vendor name 101, the component name 102, the usage purpose code 103, the functionality 104, and the price 105.

The product name 100 represents the name of the product being analyzed.

The vendor name 101 represents the name of the vendor that receives the services offered by the ASP. The component name 102 represents the name of the component that is running on the vendor's customer. The usage purpose code 103 represents the code of the purpose for which the component is running on the vendor's customer. The functionality 104 represents the functional level of each component that is offered by the vendor and is running on the vendor's customer, such as “High”, “Medium” and “Low”.

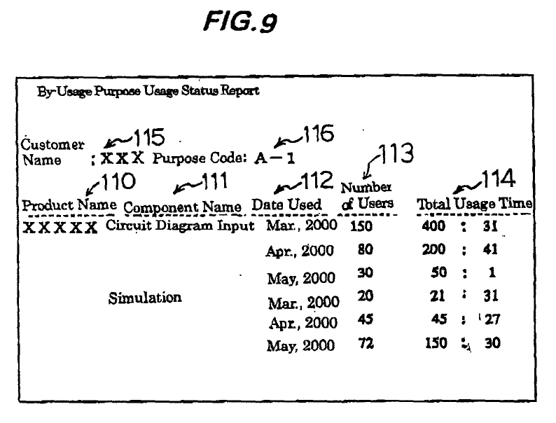

FIG. 9 shows the by-usage purpose usage status analysis report 45. This report may be generated by the by-component/by-usage purpose usage status analyzing sub-section 56 in the usage status analyzing section 25, and contains the information from the general usage purpose data 53, the by-customer usage purpose information 54, the component category information 55, and the basic accounting detail data 23a. the by-usage purpose usage status analysis report 45 may be used to know the changes in the usage status of a particular component that has been running over several months for the identical purpose. This report may be helpful in determining the software that best meets the user's needs, when an end user negotiates with a vendor to obtain the licensing agreement from the vendor.

The by-usage purpose usage status report 45 includes the following columns: the “Customer Name” column 115, the “Usage Purpose Code” column 116, the “Product Name” column 110, the “Component Name” column 111, the “Usage Date” column 112, the “Number of Users” column 113, and the “Total Usage Time” column 114.

The “Customer Name” column 115 identifies the name of the customer being analyzed. The “Usage Purpose Code” column 116 indicates the code specifying the purpose for which the product is used by the customer.

The “Product Name” column 110 indicates the name of the product that is used by the customer for the purpose specified by the code.

The “Component Name” column 111 indicates the name of the component in the product being used by the customer. The “Usage Date” column 112 indicates the date in the form of yy:mm:dd for every month. The period that is indicated in this column may be specified by the ASP.

The “Number of Users” column 113 indicates the number of users who have used each component in the month as indicated in the “Usage Date” column 112.

The “Total Usage Time” column 114 indicates the total time during which each component has been used in the month as indicated in the “Usage Date” column 112.

The usage-status analyzing section 25 in the operation server 4 includes the by-customer base product usage-status analyzing sub-section 60.

The by-customer base product usage-status analyzing sub-section 60 may analyze the product usage-status for every customer base, based on the basic accounting detail data 23a, the customer class information 58, and the by-vendor marketing strategy 59, and may generate a marketability decision report 46. The customer class information 58 and the by-vendor marketing strategy 59 may be provided by the back office 27, and include the respective data that may be extracted by the back office 27 from the database 28.

The marketability decision report 46 provides the decision-making information for the vendor's marketing strategy, which is based on the results of comparing the collection of each customer-base data with the vendor's marketing strategy (such as what customer base should be a target of the business).

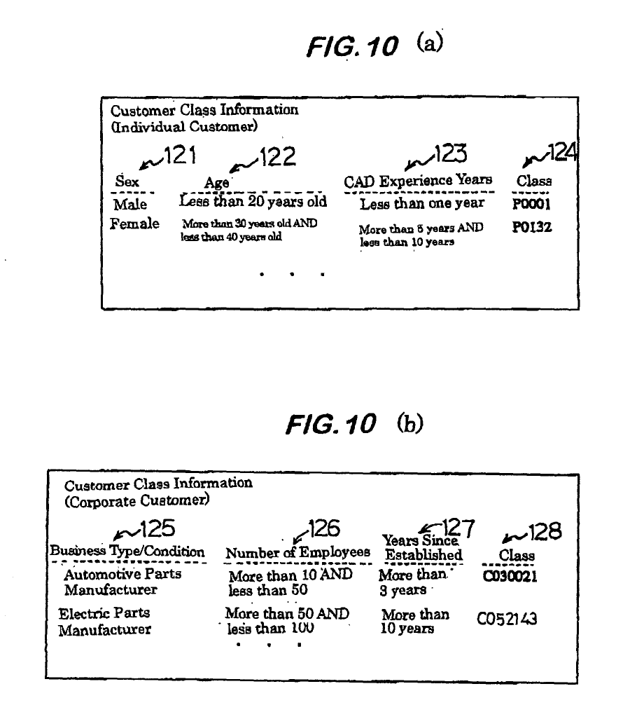

FIGS. 10 (a) and 10 (b) are examples of the customer class information for the individual customer and corporate customer that are presented in the table form, respectively.

The individual customers as shown in FIG. 10 (a) may be grouped into several classes 124, according to the information such as the sex 121 (male or female), the age 122 (such as more than 20 years old and less than 30 years old), the CAD experience years 123 (such as less than one year), and the like.

The corporate customers as shown in FIG. 10 (b) may be grouped into several classes 128, according to the information such as the business types and/or conditions 125 (such as automobile parts manufactures), the number of employees 126, the business years since the establishment 127, and the like.

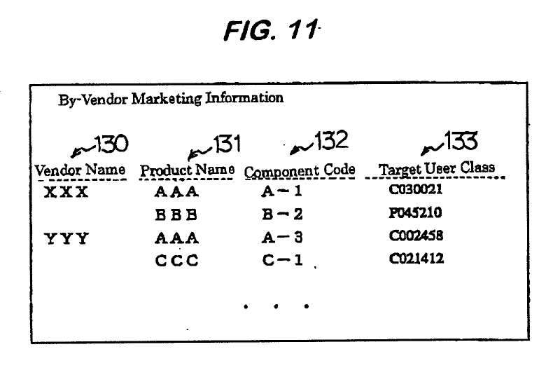

FIG. 11 represents an example of the by-vendor marketing strategy 59 that the vendor may register with the ASP. The by-vendor marketing strategy 59 includes the vendor name 130, the product name 131, the component code 132 and the target user class 133.

As it may be seen from the example of the by-vendor marketing strategy 59 shown in FIG. 11, the vendor “XXX” may consider any user in the class “C030021” as the target of selling the component, as identified by the component code “A-1”, of the product “AAA”.

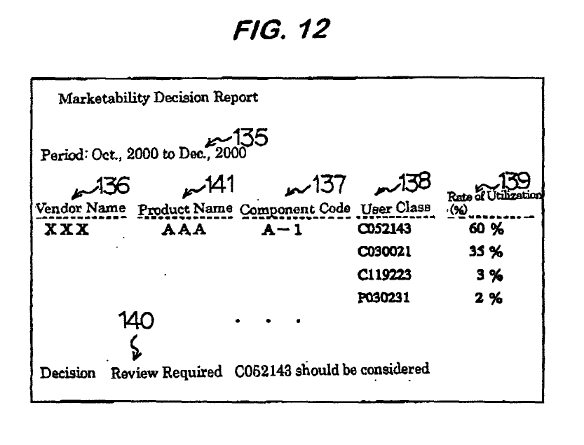

FIG. 12 represents an example of the marketability decision report 46 prepared by the by-customer base product usage-status analyzing subsection 60 in the usage-status analyzing section 25.

The marketability decision report 46 includes the following columns: the “Time Interval” column 135, the “Vendor Name” column 136, the “Product Name” column 141, the “Component Code” column 137, the “User Class” column 138, the “Rate of Utilization” column 139, and the “Decision” column 140.

The “Time Interval” column 135 indicates the period during which the analysis has been performed, which may optionally be specified by the ASP. The “Vendor Name” column 136 indicates the name of the vendor for which the analysis has been performed. The “Product Name” column 141 indicates the name of the product for which the analysis has been performed. The “Component Code” column 137 indicates the component code of the component for which the analysis has been performed. The “User Class” column 138 indicates the class of the user who has used the component as identified in the “Component Code” column 137. The “Rate of Utilization” column 137 indicates the rate of utilization (%) of the component as identified in the “Component Code” column 137 and that has been utilized by each of the users as identified in the “User Class” column 138.

The “Decision” column 140 indicates the results of the decision that has been made by comparing the elements analyzed above with the by vendor marketing strategy 59 previously provided by the vendor, the results being presented as “Good”, “Fair”, or “Review Required”.

In the example shown in FIG. 12, the vendor may consider any user in the class “C030021” as the target of selling the component “A-1”, but it is clear from the above analysis results that the user in the class “C030021” has the rate of utilization for the component “A-1” equal to 35%, whereas the user in the class “C052143” has the rate of utilization for the same component equal to 60%. From this fact, the ASP may recommend that the vendor should consider the user in the class “C052143” as the target.

The usage-status analyzing section 25 further includes a component item simulation sub-section 17 as shown in FIG. 3. The component item simulation sub-section 174 may provide the component configuration simulation, based on the basic accounting detail data 23a, the current product configuration data 171, the critical item parameter data 172, and the user's usage status data 173, and may generate an optimum component configuration analysis report 47.

The current product configuration data 171 and the critical item parameter data 172 include the respective data that may be derived from the database 28 by the back office 27.

The user's usage status data 173 includes the data that may be derived from the basic accounting detail data 23a by the back office 27.

The optimum component configuration analysis report 47 may be used by the ASP to determine the best combination of components from the availability and price rate for each component and recommend it to the vendor. Then, the ASP may build the economical version of the product that includes the best combination of the components selected by the ASP, and may offer it to the vendor.

For example, this report may be useful when the economical version of the product designed for the personal computer is built from the product originally designed for the workstation, and may also be useful when the existing platform is therefore replaced by the corresponding platform.

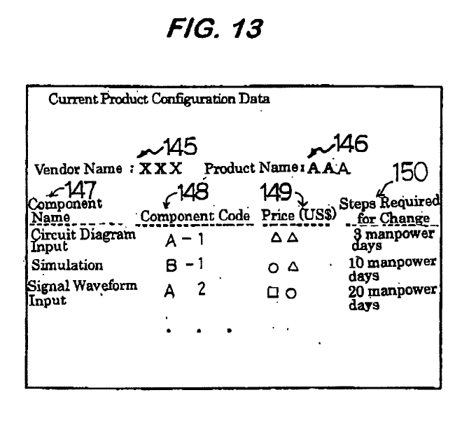

FIG. 13 represents an example of the current product configuration data 171. This data represents the component configuration of the current product.

The current product configuration data 171 includes the following columns: the “Vendor Name” column 145, the “Product Name” column 146, the “Component Name” column 147, the “Component Code” column 148, the “Price” column 149, and the “Number of Steps Required to Change the Configuration” column 150.

The “Vendor Name” column 145 identifies the name of the vendor in question.

The “Product Name” column 146 identifies the name of the original product on which the economical version is based. The “Component Name” column 147 indicates the names of the components contained in the current product that is originally designed for the circuit diagram input or simulation. The “Component Code” column 148 represents the code of each of those components. The “Price” column 149 indicates the cost of each of the components that would be configured in the economical version. The “Number of Steps Required to Change the Configuration” column 150 indicates the number of steps required to configure each component in the economical version.

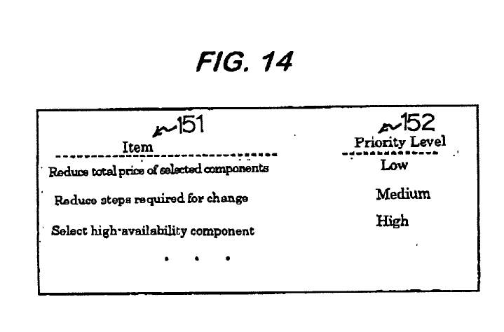

FIG. 14 represents an example of the data for the critical item parameters 172.

Those critical item parameters represent the data items that the vendor considers to be critical when preparing the economical version of the product.

The data represented by the critical item parameters 172 includes data items 151 and priority levels 152.

The data in each data item 151 suggests that “the total cost of the selected components should be reduced” or “the high-availability components should be selected”, when the economical version is built.

The priority levels 152 suggest the priority level for each of the data items 151, such as “High”, “Medium” and “Low”.

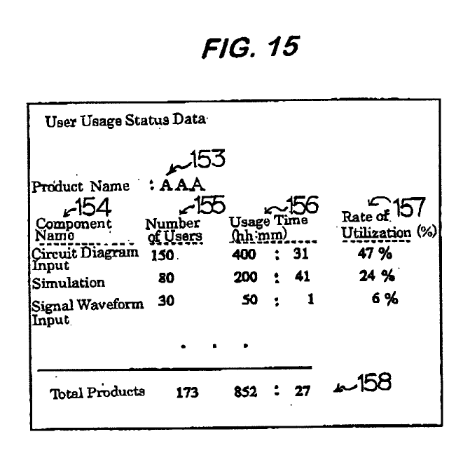

FIG. 15 represents an example of the user's usage status data 173.

The user's usage status data 173 includes the following data items: the product name 153, the component name 154, the number of users 155, the total usage time 156, the rate of utilization 157, and the total number of products 158.

The data item for the product name 153 represents the name of the original product on which the economical version is based. Each data item for the component name 154 represents the name of the component contained in the original product. Each data item for the number of users 155 represents the total number of the users who have used each component as identified in the component name 154. Each data item for the total usage time 156 represents the total time of all components as identified in the component name 154 that have been used.

Each data item for the rate of utilization 157 represents the proportion (%) of each component as identified in the component name 154 that has been used. Each data item for the total number of products 158 represents the number of users who have used the products as identified in the product name 153 as well as the total usage time of those products.

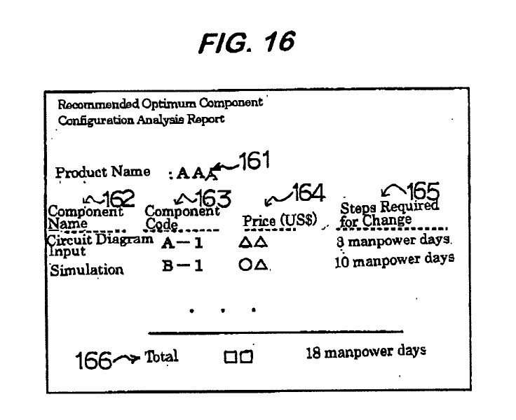

FIG. 16 represents an example of the optimum component configuration analysis report 47. This report may be generated by the component item simulation sub-section 174 in the usage-status analyzing section 25, based on the current product configuration data 171, the critical item parameters 172, and the user's usage status data 173.

This report includes the following columns: the “Product Name” column 161, the “Component Name” column 162, the “Component Code” column 163, the “Price” column 164, the “Number of Steps Required to Change the Configuration” column 165, and the “Total” column 166.

The “Product Name” column 161 identifies the name of the original product on which the economical version is based.

The “Component Name” column 162 identifies the names of the components that are to be contained in the economical version of the product. The “Component Code” column 163 indicates the component codes of the components as identified in the “Component Name” column 162. The “Price” column 164 indicates the price of the economical version of the product that will contain the components as identified in the “Component Name” column 162. The “Number of Steps Required to Change the Configuration” column 165 indicates the number of steps required when the components as identified in the “Component Name” column 162 are to be configured into the economical version of the product.

The optimum component configuration analysis report 47 may be referenced when the vendor is building the economical version by reconfiguring the original product.

According to the embodiment described so far, the ASP can keep track of how the product is used by the end user, on each individual component basis, and can charge the usage fee to the end user, based on the usage status of each individual component. In addition, the ASP can collectively analyze the respective data associated with the end user and vendor as well as the usage status data associated with each component of the product, and can provide the useful information to the end user and vendor.

In the embodiment described so far, the usage status information may be obtained for each of the components packaged into the product, but it should be understood that the present invention is limited to this embodiment. For example, the usage status information may be obtained in more details, such as on the basis of each individual function contained in each component. This variation should be understood to be included within the scope of the present invention.

Although the present invention has been described in connection with the preferred embodiment of the present invention by referring to the accompanying drawings, it should be understood that various changes and modifications may be made without departing from the spirit and scope of the invention as defined in the appended claims.

Specifically, the system according to the present invention is implemented so that it can take advantage of the networking facilities, but it should be understood that the present invention is not limited to such implementation. For example, the commercial software products that are offered by the system on the rental basis may be installed on the standalone client terminal or computer, and the user may run any of the software products on the standalone terminal. In this case, when the user runs any of the components of a product on the standalone terminal, the usage fee for that component may be charged to the user on the hourly basis. A high performance terminal or computer that has a software product installed may be supplied to the user on the rental basis, and when the user runs any of the components of the product on this computer, the usage fee for that component may be charged to the user on the hourly basis. Furthermore, a server, on which a product is installed, may be installed within a customer company, and the product may be used across the enterprise-wide LAN. In this case, the usage fee for each component of the product may be charged to the user on the hourly basis.

In the embodiment described above, all rental software products are installed on the client terminals 6a, 6b, etc. in order to improve the response of those products. It should be understood, however, that the present invention is not restricted to this embodiment. For example, all rental software products may reside on the ASP-site server, and the client terminals 6a, 6b, etc. may use any of the products by downloading it from the server via the Web browser.

In the embodiment described above, the server system 1 on the ASP site and the client system always remain interconnected through the network 7, but the connection between those sites may be disconnected and re-established as required. For example, the connection may only be established at the times when the product is to be activated and when it is to be terminated.

In the embodiment described above, the network 7 represents the Internet, but the present invention is not limited to the Internet. Other networks may be employed, such as LAN, WAN (wide area network), personal communications network, and the network via the satellite or portable terminals.

In the embodiment described above, the rental software product usually includes a collection of individual functional software components. When the product is not so built, the whole product may be rented to the user. In this case, the product that is installed on the client terminal 6a in the client system 6 has the license manager 13 built into the product. The only difference from the preceding embodiment is that the operation server 4 calculates the usage fee for the whole product, based on the usage status information such as the start time and end time. Otherwise, this variation is similar to the preceding embodiment.

What is claimed is:

1. A software rental system that offers commercial software products to one or more client systems on the rental basis over a communication network, wherein said client systems are connected to server system that includes one or more server computers through the communication network and wherein said server system includes:
use request obtaining means for receiving a request to use a software product (software use request) submitted to said server system from each of said client system over the communication network;
in response to the software use request received by said use request obtaining means, authenticating means for authenticating the user who submitted the software use request from said each client system over the communication network, by checking the identification information received with the software use request over the communication network;
after the user is authenticated by said authenticating means, licensing means for licensing the user on said each client system to use the software product as requested;
usage status obtaining means for obtaining, from said each client system and over the communication network, the usage status information for the software product licensed by said licensing means, said usage status information reflecting the actual use of the software product running on said each client system; and
usage fee calculating means for calculating the usage fee for the software product, based on the usage status information received from said usage status information obtaining means.

2. A software rental system that offers commercial software products to one or more client systems on the rental basis over a communication network, each of the commercial software products comprising a collection of individual functional software components, wherein said client systems are connected to server system that includes one or more server computers through the communication network and wherein said server system includes:
use request obtaining means for receiving a request to use a software product (software use request) submitted to said server system from each of said client system over the communication network;
in response to the software use request received by said use request obtaining means, authenticating means for authenticating the user who submitted the software use request from said each client system over the communication network, by checking the identification information received with the software use request over the communication network;
after the user is authenticated by said authenticating means, licensing means for licensing the user on said each client system to use the software product, on the basis of each of the individual functional software components packaged into the software product as requested;
usage status obtaining means for obtaining, from said each client system and over the communication network, the usage status information for each of the individual functional software components packaged into the software product licensed by said licensing means, said usage status information reflecting the actual use of each individual functional component running on said each client system; and
usage fee calculating means for calculating the usage fee for each individual functional component part, based on the usage status information received from said usage status information obtaining means.

3. The software rental system as defined in claim 2, wherein said usage status obtaining means obtains the information that reflects the actual usage time of each of the individual functional software components that are running on said each client system, and said usage fee calculating means calculates the usage fee to be charged for said each individual functional software component, based on the usage time information received from said usage status obtaining means.

4. The software rental system as defined in claim 2, wherein said usage status obtaining means obtains the frequency information that reflects how many times each individual functional software component has been used on said each client system, and said usage fee calculating means calculates the usage fee to be charged for said each individual functional software component, based on the frequency information received from said usage status obtaining means.

5. The software rental system as defined in claim 1, wherein the usage fee information provided by said usage fee calculating means is sent over the communication network to each of the client systems.

6. The software rental system as defined in claim 2, wherein the usage fee information provided by said usage fee calculating means is sent over the communication network to each of the client systems.

7. The software rental system as defined in claim 1, wherein each of the client systems remains connected to the communication network while the user on said each client system is using software product or any of the individual functional software component.

8. The software rental system as defined in claim 2, wherein each of the client systems remains connected to the communication network while the user on said each client system is using software product or any of the individual functional software component

9. The software rental system as defined in claim 1, wherein the communications between said server system and each of the client systems can occur through a firewall that only allows the signals that conform to a predetermined particular communication protocol to pass through the said firewall, and wherein the said server system includes a signal conversion means for converting the signals that can flow within the said server system into the signal format that conforms to the said particular communication protocol, and converting the signals that conform to the said particular communication protocol into the signal format that can flow within the said server system.

10. The software rental system as defined in claim 2, wherein the communications between said server system and each of the client systems can occur through a firewall that only allows the signals that conform to a predetermined particular communication protocol to pass through the said firewall, and wherein the said server system includes a signal conversion means for converting the signals that can flow within the said server system into the signal format that conforms to the said particular communication protocol, and converting the signals that conform to the said particular communication protocol into the signal format that can flow within the said server system.

11. The software rental system as defined in claim 1, wherein a commercial software product offered on the rental basis to the user on the client system is installed on the client terminal in the client system, with a first license manager being built into the said commercial software product, and a server system that offers the said rental software product contains a second license manager, and wherein the communications between said first license manager on said client system and said second license manager on said server system occur through the Internet and through the firewall that only allows the signals that conform to the particular communication protocol to pass through the firewall, each of said client system and server system including signal conversion means for converting the signals that can flow within each of said client system and server system into the signal format that conforms to the said particular communication protocol, respectively, and converting the signals that conform to the said particular communication protocol into the signal format that can flow within each of said client system and server system.

12. The software rental system as defined in claim 2, wherein a commercial software product offered on the rental basis to the user on the client system is installed on the client terminal in the client system, with a first license manager being built into the said commercial software product, and a server system that offers the said rental software product contains a second license manager, and wherein the communications between said first license manager on said client system and said second license manager on said server system occur through the Internet and through the firewall that only allows the signals that conform to the particular communication protocol to pass through the firewall, each of said client system and server system including signal conversion means for converting the signals that can flow within each of said client system and server system into the signal format that conforms to the said particular communication protocol, respectively, and converting the signals that conform to the said particular communication protocol into the signal format that can flow within each of said client system and server system.

13. A software rental method that allows commercial software products to be offered on the rental basis to one or more client systems over a communication network, wherein said client systems are connected to server system that includes one or more server computers through the communication network and wherein the method comprises:
a first step of receiving a request to use a software product (software use request) from each of said client systems over the communication network;
in response to the software use request received at said first step, a second step of authenticating the user who submitted the software use request from said each client system over the communication network, by checking the identification information received with the software use request over the communication network;
after the user is authenticated at said second step, a third step of licensing the user on said client system to use the software product as requested;
a fourth step of obtaining, from said each client system and over the communication network, the usage status information for the software product licensed at said third step, said usage status information reflecting the actual use of the software product running on said each client system; and
a fifth step of calculating the usage fee for the software product, based on the usage status information received at said fourth step.

14. A software rental method that allows commercial software products to be offered on the rental basis to client systems over a communication network, wherein said client systems are connected to server system that includes one or more server computers through the communication network and wherein the method comprises:
a first step of receiving a request to use a software product (software use request) from each of said client systems over the communication network;
in response to receipt of the software use request at said first step, a second step of authenticating the user who submitted the software use request from said each client system over the communication network, by checking the identification information received with the software use request over the communication network;
after the user is authenticated at said second step, a third step of licensing the user on said client system to use the software product as requested;
a fourth step of obtaining, from said each client system and over the communication network, the usage time information for the software product licensed at said third step, said usage time information reflecting the actual time of the software product running on said each client system; and
a fifth step of calculating the usage fee for the software product, based on the usage time information received at said fourth step.

15. A software rental method that allows commercial software products to be offered on the rental basis to one or more client systems over a communication network, each of the commercial software products comprising a collection of individual functional software components, wherein said client systems are connected to server system that includes one or more server computers through the communication network and wherein the method comprises:
a first step of receiving a request to use the software product (software use request) from each of said client systems over the communication network;
in response to the receipt of said software use request at said request receiving means, a second step of authenticating the user who submitted the software use request from said each client system over the communication network, by checking the identification information received with the software use request over the communication network;
after the user is authenticated at said second step, a third step of licensing the user on said client system to use the software product, on the basis of each of the individual functional software components contained in the software product as requested;
a fourth step of obtaining, from said each client system and over the communication network, the usage status information for each of the individual functional components licensed at said third step, said usage status information reflecting the actual status of each individual functional component running on said each client terminal; and
a fifth step of calculating the usage fee to be charged for each individual functional component, based on the usage status information received at said fourth step.

16. A software rental method that allows commercial software products to be offered on the rental basis to client systems over a communication network, each of the commercial software products comprising a collection of individual functional software components, wherein said client systems are connected to server system that includes one or more server computers through the communication network and wherein the method comprises:
a first step of receiving a request to use the software product (software use request) from each of said client system over the communication network;
in response to the receipt of said software use request at said request receiving means, a second step of authenticating the user who submitted the software use request from said each client system over the communication network, by checking the identification information received with the software use request over the communication network;
after the user is authenticated at said second step, a third step of licensing the user on said client system to use the software product, on the basis of each of the individual functional software components contained in the software product as requested;
a fourth step of obtaining, from said each client system and over the communication network, the usage time information for each of the individual functional components licensed at said third step, said usage time information reflecting the actual time of each individual functional component running on said each client terminal; and
a fifth step of calculating the usage fee to be charged for each individual functional component, based on the usage time information received at said fourth step.

17. In a software rental system that offers commercial software products to one or more client systems on the rental basis over a communication network, each of the commercial software products comprising a collection of individual functional software components, wherein said client systems are connected to server system that includes one or more server computers through the communication network, a computer program being implemented by program code means for being executed on said server system on the software rental system, said program code means including:
first program code means for receiving a request to use a software product (software use request) from each of the client systems over the communication network;
in response to the receipt of said request by said first program code means, second program code means for authenticating the user who submitted the software use request from said each client systems over the communication network, by checking the identification information received with the software use request over the communication network;
after the user is authenticated by said second program code means, third program code means for licensing the user on said client system to use the software product, on the basis of each of the individual functional software components contained in the software product as requested;
fourth program code means for obtaining, from said each client system and over the communication network, the usage status information for each of the individual functional software components licensed by said third program code means, said usage status information reflecting the actual use of each individual functional software component running on said each client system; and
fifth program code means for calculating the usage fee to be charged for each individual functional software component, based on the usage status information obtained by said fourth program code means.

18. In a software rental system that offers commercial software products to one or more client systems on the rental basis over a communication network, wherein said client systems are connected to server system that includes one or more server computers through the communication network, a computer program being implemented by program code means for being executed on said server system on the software rental system, said program code means including:
first program code means for converting received signals from the signals that conform to a predetermined particular TCP/IP application protocol having the IP header specifying the particular type protocol and the particular TCP message port number, into the signal format that is adequate for communicating within the signal receiving system, and for converting transmitting signals from the signal format that is adequate for communicating within the signal transmitting system, into the signal format that conforms to a predetermined particular TCP/IP application protocol having the IP header specifying the particular type protocol and the particular TCP message port number;
second program code means for receiving a request to use a software product (software use request) from each of the client systems over the communication network;
in response to the receipt of said software use request by said second program code means, third program code means for authenticating the user who submitted the software use request from said each client system over the communication network, by checking the identification information received with the software use request over the communication network;
after the user is authenticated by said third program code means, fourth program code means for licensing the user on said client system to use the software product as requested;
fifth program code means for receiving, from said each client system and over the communication network, the usage status information for software product licensed by said fourth program code means, said usage status information reflecting the actual use of the software product running on said each client system; and
sixth program code means for calculating the usage fee to be charged for the software product, based on the usage status information received by said fifth program code means.

19. In a software rental system that offers commercial software products to one or more client systems on the rental basis over a communication network, each of the commercial software products comprising a collection of individual functional software components, wherein said client systems are connected to server system that includes one or more server computers through the communication network, a computer program being implemented by program code means for being executed on server systems on the software rental system, said program code means including:
first program code means for converting received signals from the signals that conform to a predetermined particular TCP/IP application protocol having the IP header specifying the particular type protocol and the particular TCP message port number, into the signal format that is adequate for communicating within the signal receiving system, and for converting transmitting signals from the signal format that is adequate for communicating within the signal transmitting system into the signal format that conforms to a predetermined particular TCP/IP application protocol having the IP header specifying the particular type protocol and the particular TCP message port number;
second program code means for receiving a request to use a software product (software use request) from each of the client systems over the communication network;
in response to the receipt of said software use request by said second program code means, third program code means for authenticating the user who submitted the software use request from said each client systems over the communication network, by checking the identification information received with the software use request over the communication network;
after the user is authenticated by said third program code means, fourth program code means for licensing the user on said client system to use the software product, on the basis of each of the software components contained in the software product as requested;
fifth program code means for receiving, from said each client system and over the communication network, the usage status information for each of the software components contained in the software product as licensed by said fourth program code means, said usage status information reflecting the actual use of each software component running on said each client system; and
sixth program code means for calculating the usage fee to be charged for each software component, based on the usage status information received by said fifth program code means.
